(19) United States
(12) Patent Application Publication
(10) Pub. No.: US 2009/0292609 A1
(43) Pub. Date: Nov. 26, 2009

(54) METHOD AND SYSTEM FOR DISPLAYING ADVERTISEMENT LISTINGS IN A SPONSORED SEARCH ENVIRONMENT

(75) Inventor: Anantha Krishnan Vaidyanathan, Bangalore (IN)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/124,099

(22) Filed: May 20, 2008

(51) Int. Cl. G06Q 30/00; G06F 3/048; G06F 17/30; G06F 7/06

(52) U.S. Cl. 705/14.49; 715/760; 707/3; 707/E17.014

(57) ABSTRACT

A method and system for displaying advertisement listings in a sponsored search environment is provided. The method and system may include generating an advertisement list in response to receiving a search request for a search term, where advertisements in the advertisement list are associated with the search term; defining a region of a display screen for displaying the advertisement list; and communicating web page instructions to a browser for scrolling the advertisement listings through the region, where only a subset of the advertisements listings are displayed at any given time. The advertisements in the advertisement list may be scrolled from top to bottom or visa versa, and left to right or visa versa. The method and system may also include providing a scroll control that enables controlling which advertisements in the advertisement list are displayed in the scrolling region.

### BACKGROUND

1. Field of Invention

The present invention relates to sponsored search advertising in an Internet environment. Specifically, the present invention relates to a method and system for displaying advertisement listings in a sponsored search environment.

2. Background Information

The Internet has emerged as a powerful tool for finding information. Various search engines are now available that enable Internet users, via a web browser, to search for information on a variety of topics. In some cases, the searchers may be utilizing a browser on a mobile device, such as cellular telephone. Browsing from a mobile device may be very useful. For example, a searcher looking for a specific location may navigate to a website hosting a search engine and submit a search term, such as “restaurants” to the search engine. After submitting the search term, the search engine may provide a search result list to the searcher. The search result list may include a list of websites, which may include the search term.

These search services may be provided free of charge to the searcher. However, to cover the cost for these services, some search providers may include advertisements in the search result list. Advertisers may pay the search providers to have their respective advertisements listed along with other websites in the search result list. In some instances, the advertisers may pay to have their advertisements associated with search terms that may be related to the search terms submitted by the searcher. This may allow the advertiser to target advertisements to searchers who may be more likely to purchase the advertiser's products or services. This type of arrangement has come to be known as sponsored search because the advertisers are essentially sponsoring the search. The search providers providing these services have come to be called sponsored search providers.

One problem with this arrangement, however, is that there may be more advertisers willing to associate their respective advertisements with search terms than there is space available on a display. One reason is that the search providers, in an effort to maintain the user experience, may need to maintain a certain amount of display screen real estate for ordinary search hits. Thus, a searcher may only be exposed to relatively few ad listings in any given search session. This problem may be exacerbated in the mobile device environment where display real estate may be at a premium.

### BRIEF SUMMARY

To address the problems outlined above, a method and system for displaying advertisement listings in a sponsored search environment are provided. The method and system may include generating a number of advertisement listings in response to receiving a search request for a search term, defining a region of a display screen for displaying the advertisement listings; and communicating web page instructions to a browser for scrolling the advertisement listings through the region, where only a subset of the advertisement listings are displayed at any given time. The region for displaying the advertisement listings may be at the top, bottom, and/or sides of the display screen. Advertisements may be scrolled in a top to bottom, left to right, or opposite direction. The region may be defined in terms of a number of pixels, a number of lines, and/or a number of advertisements.

The method may also include receiving information related to a display screen. In one embodiment, this information may include data related to the size of the display screen. In another embodiment, this information may be utilized to retrieve information from a database, which may include data related to the display screen. The information may be utilized to define the region for displaying the advertisements.

In yet another embodiment, a scroll control may be provided. The scroll control may be utilized to control which advertisement listings are displayed in the scrolling region.

### BRIEF DESCRIPTION OF THE DRAWINGS

FIG. 1 is a diagram of a system for providing a sponsored search listing;

FIG. 2A is a web page with scrolling advertisements that may correspond to a search result list;

FIG. 2B is an ad listing region of a web page demonstrating scrolling advertisement listings in the ad listing region;

FIG. 2C is a web page with a region for scrolling advertisements where a user may control the scrolling;

FIG. 3 is a flow diagram for creating a web page with a search result list;

FIG. 4 is a flow diagram for scrolling advertisement listings in an ad listing region of a search result list; and

FIG. 5 illustrates a general computer system, which may represent any of the computing devices referenced herein.

### DETAILED DESCRIPTION OF THE DRAWINGS AND THE PRESENTLY PREFERRED EMBODIMENTS

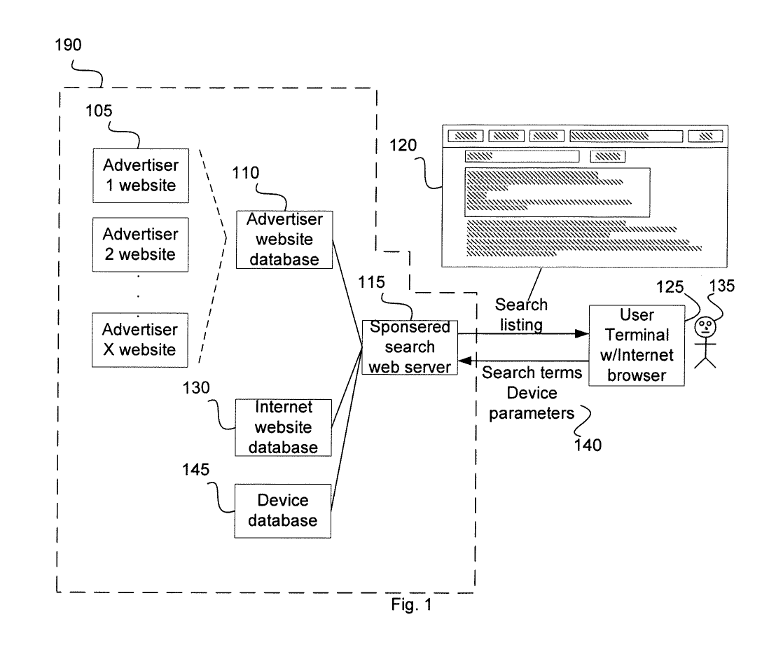

FIG. 1 is a diagram of a system 190 for providing a sponsored search listing with scrolling ads. The system 190 includes a series of advertiser websites 105, an advertiser website database 110, an Internet website database 130, a device attributes database 145, and a sponsored search web server 115. Also shown in FIG. 1 is a search result web page 120, a user terminal 125, and a searcher 135.

The sponsored search web server 115 may comprise suitable logic, code, and/or circuitry that may enable generating web pages, including sponsored search web pages that include a search result web page 120, where the search result list 120 may be associated with search terms. For example, sponsored search web server 115 may correspond to an Intel® based computer running applications such as Apache® or Microsoft Internet Information Server®, which may be utilized to generate the web pages. The sponsored search web server 115 may be implemented using any conventional computer or other data processing device. The sponsored search web server 115 may further be implemented using a specialized data processing device which has been particularly adapted to perform the functions of a sponsored search web server 115. These functions may include communicating with a searcher 135 operating an Internet browser running on a user terminal 125. The sponsored search web server 115 may also be adapted to communicate with other networked equipment and to retrieve information from various databases, such as an advertiser website database 110, an Internet website database 130, and/or a device attribute database 145. The communicated information may include data defining text, images, video, audio or other information.

The user terminal 125 may comprise suitable logic, code, and/or circuitry that may enable communicating information over a network connection, such as an Internet connection. For example, the user terminal 125 may correspond to an Intel® based computer running a Windows®operating system with a browser, such as Internet Explorer®. The user terminal 125 may be adapted to display web pages communicated from a web server, such as a search result list 120 generated by a sponsored search web server 115. The user terminal 125 may also be adapted to communicate search terms and device parameters, associated with an Internet browser operating on the user terminal 125, to the sponsored search web server 115.

The advertiser website database 110, the Internet website database 130, and the device attributes database 145 may be in communication with the sponsored search web server 115. The advertiser website database 110 may include advertisement listings corresponding to the advertiser websites 105 as well as search terms that may be associated with the advertisement listings. The Internet website database 130 may include links to websites found on the Internet. The Internet website database 130 may, for example, be populated by executing a web crawler algorithm on the Internet. This algorithm may search the Internet for websites and collect terms found on the websites for association with the website and store links to the websites along with their associated terms. The device attributes database 145 may include information related to the attributes of various devices. For example, the device attributes database 145 may include a list of mobile devices along with various screen attributes, such as the screen resolution, or whether the screen can reproduce color images.

In operation, a searcher 135 may, through an Internet browser running on a user terminal 125, navigate to a website hosted on the sponsored search web server 115 and specify search terms. The search terms may be communicated to the sponsored search web server 115, which may then communicate a search result list 120 to the user terminal 125. The search result list 120 may be related to the search terms provided by the searcher 135. The search result list 120 may include links to advertiser web pages and other web pages that may be related to search terms provided by the searcher 135. The sponsored search web server 115 may accomplish this by searching through the advertiser website database 110 for any advertiser websites 105 that have search terms that may be related to the search terms provided by the searcher 135. For example, the websites may be related because the underling code associated with the website contains the search term. Alternatively, the websites may be matched based on the content. For example, the search term “sports” may lead to a website related to sports. The search terms may be related in other ways as well. For example, it may be known through statistical methods that searchers searching for a particular keyword are interested in certain products. In this case, websites with those products may be matched to the search terms.

In one embodiment, device parameters 140 corresponding to the display screen of the user terminal 125 may be communicated to the sponsored search web server 115 along with the search terms. The device parameters 140 may, for example, represent the size of an Internet browser operating on the user terminal 125. For example, the horizontal and vertical size in terms of pixels or inches may be provided. These device parameters 140 may be utilized by the sponsored search web server 115 to determine how much space may be available for displaying advertisement listings within the Internet browser.

In another embodiment, the device parameters 140 may include information related to the type of user terminal 125. This information may be utilized by the sponsored search web server 115 to retrieve attributes related to the type of user terminal from the device database 145. These attributes may then be utilized by the sponsored search web server 115 to determine how much space may be available for displaying advertisement listings.

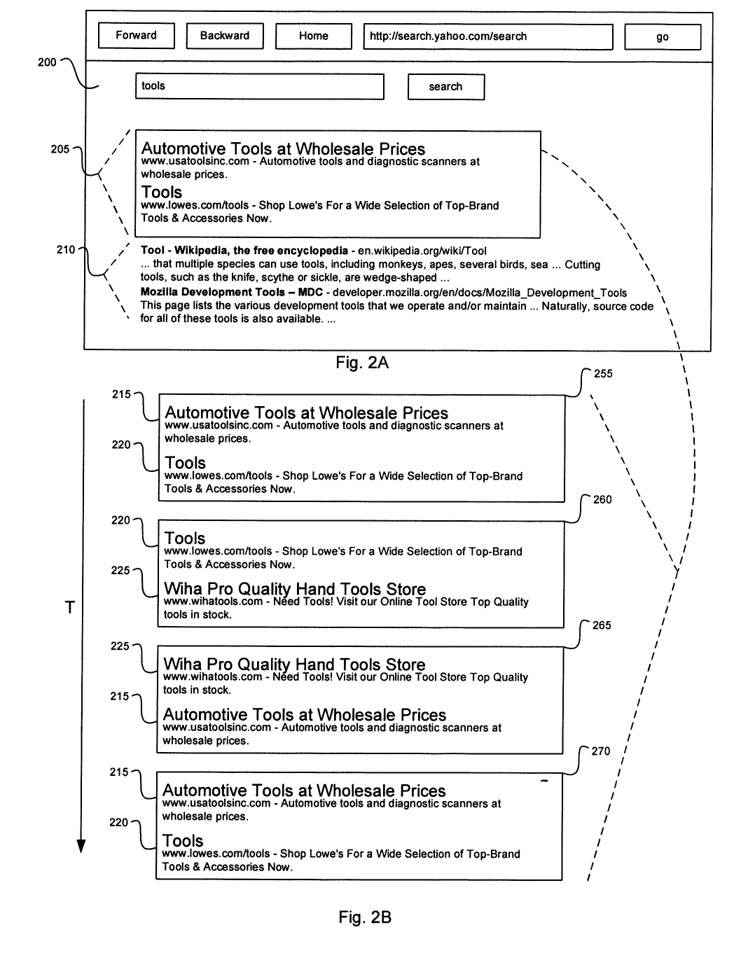

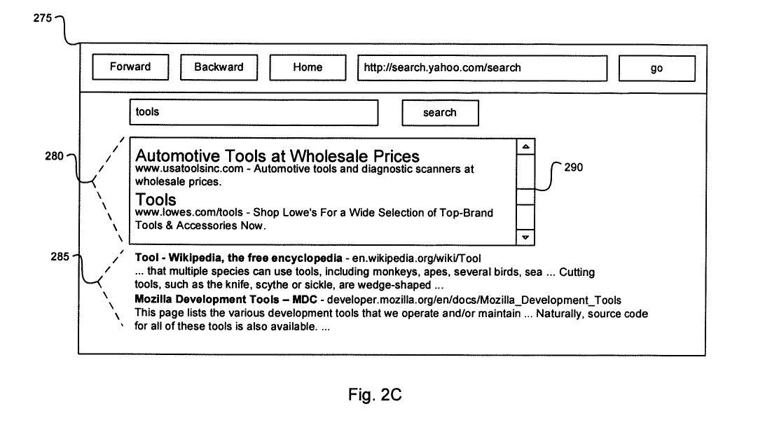

FIG. 2A is a web page with scrolling advertisements that may correspond to the search result list 120 shown in FIG. 1. Shown in FIG. 2A is a search result list web page 200, an ad listings region 205, and a region for other web page listings 210. The search result list web page 200 may be displayed in aninternet browser operating on a user terminal 125 in response to a search term being provided by a searcher 135. For example, the searcher 135 may have submitted the term “tools” to a search engine, such as the sponsored search web server 115 shown in FIG. 1. The search engine may then communicate the search result list web page 200 shown in FIG. 2A to the user terminal 125. The links to other web page listings 210 may correspond to a series of web pages that include the search term. These links may be stored in an Internet website database 130. For example, a particular web page may include the text “tool.” As a result, a listing corresponding to that web page may be shown in the region for other web page listings 210.

The ad listing region 205 may be utilized for displaying advertisement listings. In some instances, the advertisements may be statically displayed. That is, the advertisements may not scroll. In other instances, where there may be more advertisements to display than real estate available on the display screen, the advertisements may be rolled within the ad listing region 205 of the display screen as shown in FIG. 2B.

FIG. 2B is an ad listing region of a web page demonstrating scrolling advertisement listings in the ad listing region. Shown in FIG. 2B is an ad listing region at first, second, and third times 255, 260, 265; and first, second, and third advertisement listings 215, 220, 225. At the first time 255, the first and second advertisement listings 215 and 220 may be shown. At the second time 260, the second and third advertisement listings 220 and 225 may be shown. At the third time 265, the third and first advertisement listings 225 and 215 may be shown. The cycle may then repeat. Scrolling the ads in this manner may enable displaying more advertisements to a searcher than would otherwise be possible given the space constraints of the web browser window. Although only three advertisement listing are shown in the example more or few advertisement listings may be shown.

Other embodiments are contemplated as well. For example, in additional to the upward scrolling described in FIG. 2B the advertisements may be scrolled in a downward direction, a sideways direction, or any combination thereof. The advertisements may scroll gradually, for example pixel by pixel, line by line, or ad by ad. A first set of advertisement listings may be shown for a time then phased out and replaced by a second set of advertisement listings. Any combination of these techniques may be utilized as well.

Yet in another embodiment the searcher 135 may be able to interact with the ad listing region. For example, as shown in FIG. 2C, a scroll bar 290 may be associated with the ad listing region 280. Using a pointing device, such as a mouse, a searcher may be able to operate the scroll bar 290 to control which advertisement listings are displayed in the ad listing region 280. This may enable the searcher 135 to bring back into view an advertisement listing that may have rolled off. For example, one of the advertisement listings may have caught the eye of the searcher 135, but may have rolled off the screen. The searcher 135 may, via the scroll bar 290, scroll the advertisement back into view.

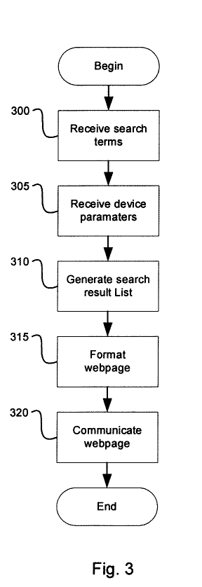

FIG. 3 is a flow diagram for creating a search result list web page 200. The blocks shown in the flow diagram may, for example, be utilized by the sponsored search web server 115 to create web pages with scrolling ads. Referring to FIG. 3, at block 300 search terms may be received. For example, the sponsored search web server 115 may via a network connection receive search terms specified by a searcher 135. The searcher 135 may have specified the search terms via an Internet browser running on a user terminal 125. At block 305, device parameters 140 may be received. For example, parameters related to the Internet browser window operating on an a user terminal 125 may be communicated to the sponsored search web server 115. The device parameters 140 may, for example, represent the size of the Internet browser window where the search result list 120 may be viewed. For example, the horizontal and vertical size in terms of pixels or inches may be provided. These device parameters 140 may be utilized by the sponsored search web server 115 to determine how much space may be available for displaying advertisement listings.

The device parameters 140 may also correspond to the type of user terminal 125. For example, the device parameters 140 may indicate that the user terminal 125 is a PDA type device with a large display screen. The sponsored search web server 115 may then utilize this information to retrieve device attributes for the device from the device attributes database 145. These attributes may then be utilized to determine how much real estate may be available for displaying advertisement listings.

At block 310, a result list may be generated. For example, the sponsored search web server 115 may generate a list of web sites related to the search terms received at block 300. The search result list web page 200 may include advertisement listings and other web page listings. At block 315, a web page with a region for scrolling advertisement listings may be generated. For example, a web page may be generated by the sponsored search web server 115. The web page may correspond to a web page such as the search result list web page 200 shown in FIG. 2A. The web page may include an ad listings region 205, and a region for other web page listings 210. The ad listing region 205 may display the advertisements by scrolling them vertically and/or horizontally. At block 320, the web page may be communicated to an internet browser operating on a terminal, such as the user terminal 125 shown in FIG. 1. The process may then end.

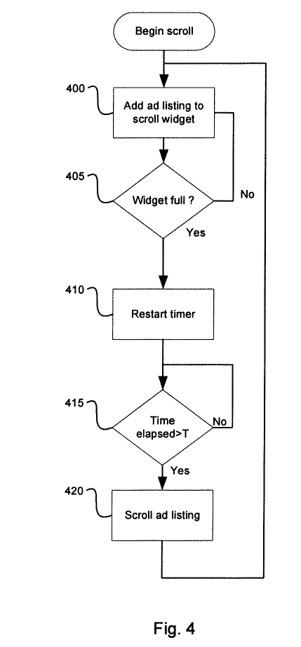

FIG. 4 is a flow diagram for scrolling advertisement listings in an ad listing region 205 of a search result list. At block 400, an ad listing may be added to the ad listing region 205 of a search result list. For example, a first advertisement listing 215 may be added to the ad listing region 205 of a search result list, as shown in FIG. 2B. At block 405, if the region is not full, then another ad listing may be added to the region at block 400. For example, a second advertisement listing 220 may be added, as shown in FIG. 2B.

If the ad listing region is full, at block 410 a timer may be started. The timer may be utilized to allow a certain group of advertisement listings to be displayed in the ad listing region 205 for a predetermined amount of time. The timer may be implemented via software and/or hardware on the user terminal 125. At block 415, if the predetermined amount of time has elapsed, then at block 420 the first advertisement listing displayed in the ad listing region 205 may be scrolled out of the ad listing region 205. The process may then return to block 400 where another advertisement listing may be added to the ad listing region 205. For example, as shown in FIG. 2B the first advertisement listing 215 may scroll out of the ad listing region 205 and a third advertisement listing 225 may be scrolled in. This process may be repeated to enable displaying more advertisement listings in the ad listing region 205 than would otherwise be possible with a static set of listings. The scrolling may be accomplished by graphically moving the first and second advertisement listings by a number of pixels, a number of lines, or a number of advertisements. In this manner, it may be made to appear as though the first advertisement listing is gradually erased while at the same time the third advertisement listing gradually comes into view.

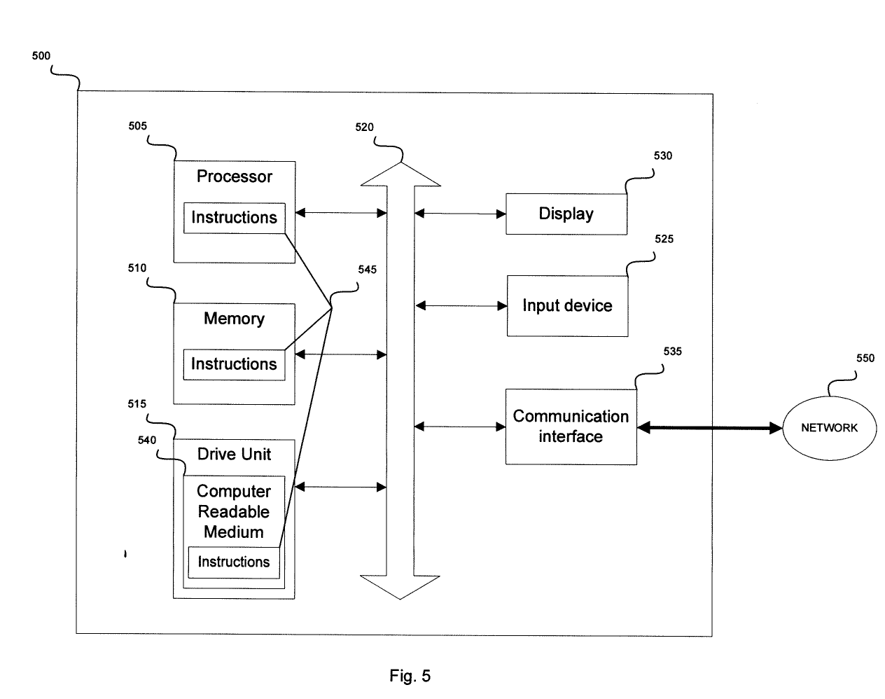

FIG. 5 illustrates a general computer system, which may represent a sponsored search web server 115, user terminal 125, or any of the other computing devices referenced herein. The computer system 500 may include a set of instructions 545 that may be executed to cause the computer system 500 to perform any one or more of the methods or computer based functions disclosed herein. The computer system 500 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 500 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 545 (sequential or otherwise) that specify actions to be taken by that machine. In one embodiment, the computer system 500 may be implemented using electronic devices that provide voice, video or data communication. Further, while a single computer system 500 may be illustrated, the term “system” shall also be taken to include any collection of systems or sub-systems that individually or jointly execute a set, or multiple sets, of instructions to perform one or more computer functions.

As illustrated in FIG. 5, the computer system 500 may include a processor 505, such as a central processing unit (CPU), a graphics processing unit (GPU), or both. The processor 505 may be a component in a variety of systems. For example, the processor 505 may be part of a standard personal computer or a workstation. The processor 505 may be one or more general processors, digital signal processors, application specific integrated circuits, field programmable gate arrays, servers, networks, digital circuits, analog circuits, combinations thereof, or other now known or later developed devices for analyzing and processing data. The processor 505 may implement a software program, such as code generated manually (i.e., programmed).

The computer system 500 may include a memory 510 that can communicate via a bus 520. For example, the advertiser website database 110, Internet website database 130, and device attributes database 145 may be stored in the memory. The memory 510 may be a main memory, a static memory, or a dynamic memory. The memory 510 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 510 may include a cache or random access memory for the processor 505. Alternatively or in addition, the memory 510 may be separate from the processor 505, such as a cache memory of a processor, the system memory, or other memory. The memory 510 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 510 may be operable to store instructions 545 executable by the processor 505. The functions, acts or tasks illustrated in the figures or described herein may be performed by the programmed processor 505 executing the instructions 545 stored in the memory 510. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 500 may further include a display 530, such as a liquid crystal display (LCD), an organic light emitting diode (OLED), a flat panel display, a solid state display, a cathode ray tube (CRT), a projector, a printer or other now known or later developed display device for outputting determined information. The display 530 may act as an interface for the user to see the functioning of the processor 505, or specifically as an interface with the software stored in the memory 510 or in the drive unit 515.

Additionally, the computer system 500 may include an input device 525 configured to allow a user to interact with any of the components of system 500. The input device 525 may be a number pad, a keyboard, or a cursor control device, such as a mouse, or a joystick, touch screen display, remote control or any other device operative to interact with the system 500.

The computer system 500 may also include a disk or optical drive unit 515. The disk drive unit 515 may include a computer-readable medium 540 in which one or more sets of instructions 545, e.g. software, can be embedded. Further, the instructions 545 may perform one or more of the methods or logic as described herein. The instructions 545 may reside completely, or at least partially, within the memory 510 and/or within the processor 505 during execution by the computer system 500. The memory 510 and the processor 505 also may include computer-readable media as discussed above.

The present disclosure contemplates a computer-readable medium 540 that includes instructions 545 or receives and executes instructions 545 responsive to a propagated signal; so that a device connected to a network 550 may communicate voice, video, audio, images or any other data over the network 550. The instructions 545 may be implemented with hardware, software and/or firmware, or any combination thereof. Further, the instructions 545 may be transmitted or received over the network 550 via a communication interface 535. The communication interface 535 may be a part of the processor 505 or may be a separate component. The communication interface 535 may be created in software or may be a physical connection in hardware. The communication interface 535 may be configured to connect with a network 550, external media, the display 530, or any other components in system 500, or combinations thereof. The connection with the network 550 may be a physical connection, such as a wired Ethernet connection or may be established wirelessly as discussed below. Likewise, the additional connections with other components of the system 500 may be physical connections or may be established wirelessly.

The network 550 may include wired networks, wireless networks, or combinations thereof. Information related to business organizations may be provided via the network 550. The wireless network may be a cellular telephone network, an 802.11, 802.16, 802.20, or WiMax network. Further, the network 550 may be a public network, such as the Internet, a private network, such as an intranet, or combinations thereof, and may utilize a variety of networking protocols now available or later developed including, but not limited to TCP/IP based networking protocols.

The computer-readable medium 540 may be a single medium, or the computer-readable medium 540 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 540 may include a solid-state memory such as a memory card or other package that houses one or more non-volatile read-only memories. The computer-readable medium 540 also may be a random access memory or other volatile re-writable memory. Additionally, the computer-readable medium 540 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The method and system may also be embedded in a computer program product, which included all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments falling within the scope of the appended claims.

From the foregoing, it may be seen that the embodiments disclosed herein provide an improved approach for displaying advertisements in a sponsored search environment. Rather than simply displaying a static display of advertisement listings, which limits the number of advertisement listings that may be displayed, this approach defines a region of a search result list web page where advertisement listings may be scrolled. This effectively increases the number of advertisement listings that may be targeted at a searcher.

1. A method for displaying advertisement listings in an Internet environment, the method comprising:
generating a plurality of advertisement listings in response to receiving a search request;
defining a region of a display screen for displaying the advertisement listings; and
communicating web page instructions to a browser for scrolling the advertisement listings through the region, wherein only a subset of the advertisements listings are displayed in the region at any given time.

2. The method according to claim 1, wherein the region of the display for displaying the advertisement listings corresponds to at least one of: a top, side, and bottom region of the display screen.

3. The method according to claim 1, wherein the advertisement listings are scrolled and the direction of scrolling corresponds to at least one of: a top to bottom, bottom to top, left to right, and right to left direction.

4. The method according to claim 1, further comprising providing a scroll control that enables controlling which advertisement listings are displayed in the scrolling region.

5. The method according to claim 1, wherein the region is defined in terms of at least one of: a number of pixels, a number of lines, and a number of advertisement listings.

6. The method according to claim 1, further comprising receiving information related to the display screen.

7. The method according to claim 6, further comprising retrieving information from a database related to the received information where at least some of the information is utilized to define the region.

8. A machine-readable storage medium having stored thereon, a computer program comprising at least one code section for displaying advertisement listings in an Internet environment, the at least one code section being executable by a machine for causing the machine to perform acts of:
generating a plurality of advertisement listings in response to receiving a search request;
defining a region of a display screen for displaying the advertisement listings; and
communicating web page instructions to a browser for scrolling the advertisement listings through the region, wherein only a subset of the advertisements listings are displayed in the region at any given time.

9. The machine-readable storage medium according to claim 8, wherein the region of the display for displaying the advertisement listings corresponds to at least one of: a top, side, and bottom region of the display screen.

10. The machine-readable storage medium according to claim 8, wherein the advertisement listings are scrolled and the direction of scrolling corresponds to at least one of: a top to bottom, bottom to top, left to right, and right to left direction.

11. The machine-readable storage medium according to claim 8, wherein the at least one code section comprises code that enables providing a scroll control that enables controlling which advertisement listings are displayed in the scrolling region.

12. The machine-readable storage medium according to claim 8, wherein the region is defined in terms of at least one of: a number of pixels, a number of lines, and a number of advertisement listings.

13. The machine-readable storage medium according to claim 8, wherein the at least one code section comprises code that enables receiving information related to the display screen.

14. The machine-readable storage medium according to claim 13, wherein the at least one code section comprises code that enables retrieving information from a database related to the received information where at least some of the information is utilized to define the region.

15. A system for displaying advertisement listings in an Internet environment, the system comprising:
circuitry that enables generating a plurality of advertisement listings in response to receiving a search request;
the circuitry also enables defining a region of a display screen for displaying the advertisement listings; and communicating web page instructions to a browser for scrolling the advertisement listings through the region, wherein only a subset of the advertisements listings are displayed in the region at any given time.

16. The system according to claim 15, wherein the region of the display for displaying the advertisement listings corresponds to at least one of: a top, side, and bottom region of the display screen.

17. The system according to claim 15, wherein the advertisement listings are scrolled and the direction of scrolling corresponds to at least one of: a top to bottom, bottom to top, left to right, and right to left direction.

18. The system according to claim 15, wherein the circuitry enables providing a scroll control that enables controlling which advertisement listings are displayed in the scrolling region.

19. The system according to claim 15, wherein the region is defined in terms of at least one of: a number of pixels, a number of lines, and a number of advertisement listings.

20. The system according to claim 15, wherein the circuitry enables receiving information related to the display screen.

21. The system according to claim 20, wherein the circuitry enables retrieving information from a database related to the received information where at least some of the information is utilized to define the region.

22. A method for displaying advertisement listings in an Internet environment, the method comprising:
generating an advertisement list in response to receiving a search request;
receiving screen parameters, wherein the parameters comprise information related to a size of a mobile device screen;
defining a region of the mobile device screen for displaying the advertisement list, wherein the region is defined at least in part based on the received screen parameters; and
communicating web page instructions to a browser operating on the mobile device for scrolling the advertisement listings through the region, wherein only a subset of the advertisements listings are displayed at any given time.
